(19) United States
(12) Patent Application Publication
(10) Pub. No.: US 2025/0067319 A1
(43) Pub. Date: Feb. 27, 2025

(54) SEALED SELF-LUBRICATING ROLLER CHAIN

(71) Applicant: AKTIEBOLAGET SKF, GOTEBORG (SE)

(72) Inventor: Izak Cornelius VAN ZYL, Woudenberg (NL)

(21) Appl. No.: 18/795,503

(22) Filed: Aug. 6, 2024

(30) Foreign Application Priority Data
Aug. 25, 2023 (DE) 102023208146.6

(51) Int. Cl. F16G 13/06; F16C 33/74

(52) U.S. Cl. CPC F16G 13/06; F16C 33/74; F16C 2361/71

(57) ABSTRACT

A roller chain includes a bush having first and second ends, a pin extending through the bush and having first and second ends projecting from the bush, a roller supported by an outer surface of the bush, a first inner link having an opening mounted on the first end of the bush and a second inner link having an opening mounted on the second end of the bush, a first outer link having an opening mounted on the first end of the pin and a second outer link having an opening mounted at the second end of the pin, and a first seal body axially mounted between the first inner link and the first outer link and a second seal body axially mounted between the second inner link and the second outer link, wherein the bush comprises a sintered cylinder impregnated with a lubricant.

### CROSS-REFERENCE

This application claims priority to German patent application no. 10 2023 208 146.6 filed on Aug. 25, 2023, the contents of which are fully incorporated herein by reference.

### TECHNOLOGICAL FIELD

The present disclosure is directed to the lubrification of roller chains, especially roller chains for transporting products and goods, for example in packaging machines, in the electronics industry, in the food industry, in the beverage industry, in the agriculture industry or in paper machines.

### BACKGROUND

Conveying systems generally include a conveying means for transporting products and goods. Roller chains are a well-known type of conveying means. Roller chains generally comprise a plurality of successively aligned rollers, the rollers being rotatably mounted on pins, ends of two successive pins being linked together by side plates.

It is essential to lubricate the parts of roller chains where friction occurs. For example, lubrication may be provided between pins and rollers and between pins and side plates to maintain optimum mechanical conditions, to reduce maintenance tasks and related costs, and to increase service life. Lubricant can be applied manually during a regular maintenance process, but it is often desirable to perform lubrication while the roller chain is running. Moreover, access to roller chain may be restricted or impossible for safety reasons.

Automatic lubrication systems are preferably used to lubricate roller chains to allow for more frequent and regular lubrication of a roller chain at any time and at any desired location without stopping the roller chain.

A lubricant applicator may comprise a brush in continual contact with the roller chain, an air spray nozzle to spray lubricant volumes with a regulated air flow at the same time, or an airless nozzle. However, there is always a risk that when lubricant is applied in this manner it will come into contact with products being moved using the roller chains, thus, damaging the products.

### SUMMARY

One aspect of the present disclosure is to solve the problems indicated above, and thus to provide a roller chain that reduces the need to periodically stop the moving roller chain to lubricate it. Another aspect of the disclosure is to provide a roller chain that reduces the risk of lubricant coming into contact with products being transported by a mechanism that includes a roller chain.

In another aspect, a roller chain comprises at least one outer link and at least one inner link articulated in relation to each other. The outer link comprises a first outer plate and a second outer plate spaced from the first outer plate. The inner link is arranged partially between first and second outer plates of the outer link. The inner link comprises a first inner plate with at least a first through-hole and a second inner plate with at least a second through-hole coaxial with the first through-hole, the second inner plate of the inner link being spaced from the first inner plate.

The roller chain also includes at least one bush passing through the first through-hole of the first inner plate and the second through-hole of the second inner plate of the inner link, at least one pin inserted into the bush and connected to the first outer plate and to the second outer plate of the outer link and at least one roller arranged between first and second inner plates of the inner link and surrounding the bush. According to a general feature, the bush is sintered and impregnated with a lubricant.

The roller chain further comprises at least a first seal axially disposed between the first inner plate of the inner link and the first outer plate of the outer link and at least a second seal axially disposed between the second inner plate of the inner link and the second outer plate of the outer link.

The bush, sintered and impregnated with lubricant, releases lubricant while the roller chain is in motion, thus lubricating the interface between the pin and the bush, between the bush and the roller, between the bush and the first outer plate of the outer link, and between the bush and the second outer plate of the outer link.

The first seal and the second seal act as a protective barrier against the ingress of foreign material, such as dust and other dirt particles, between the bush and the pin thus allowing the use of the roller chain in locations having high moisture and/or in dusty applications. The first seal and the second seal protect the sintered bush and avoid the spilling of the lubricant impregnated into the bush.

This roller chain is a self-lubricating chain which offer a long-lasting maintenance-free solution. Planned lubrication intervals are unnecessary and maintenance costs are reduced accordingly.

The bush may axially protrude with respect to the first inner plate of the inner link and may form a seat for the first seal. The seat for the first seal formed by the bush provides radial centering of the first seal and insure that the first seal being well located for optimum sealing efficiency. The bush may also axially protrude with respect to the second inner plate of the inner link and may form a seat for the second seal. The seat for the second seal formed by the bush provides radial centering of the second seal and insure that the second seal being well located for optimum sealing efficiency.

The first seal may be axially in contact with the first inner plate of the inner link and/or axially in contact with the first outer plate of the outer link. The second seal may be axially in contact with the second inner plate of the inner link and or axially in contact with the second outer plate of the outer link.

The first and/or second inner plate of the inner link may be coated with black oxide or nickel plated. The first and/or second outer plate of the outer link may be coated with black oxide or nickel plated.

The first and/or second seal may comprise a X-ring or an O-ring seal, and the lubricant may comprise oil. The first and/or second seal may be made of a polymer or an elastomeric material. For example, the first and/or second seal may be made from urethane or from a fluoroelastomer such as Viton™.

Another aspect of the disclosure comprises a roller chain that includes a bush having a first end and a second end, a pin extending through the bush and having a first end extending from the first end of the bush and a second end extending from the second end of the bush, and a roller supported by an outer surface of the bush and having a first end and a second end. A first inner link has a first opening mounted on the bush at the first end of the roller and a second inner link has a first opening mounted on the bush at the second end of the roller. A first outer link has a first opening mounted on the first end of the pin and a second outer link has a first opening mounted at the second end of the pin. A first seal body is axially mounted between the first inner link and the first outer link, and a second seal body is axially mounted between the second inner link and the second outer link. The bush is a sintered cylinder impregnated with a lubricant.

The disclosure is also directed an assembly process of a roller chain as defined above that includes the following steps: a lubricant projection step onto the bush, and an assembly step of the pin, the bush, the roller, the inner link, the outer link, the first seal and the second seal.

### BRIEF DESCRIPTION OF THE DRAWINGS

Other advantages and features of the invention will appear from the detailed description of embodiments of the invention, which are non-limiting examples, illustrated on the appended drawings of which:

FIG. 1 is a schematic front view of a roller chain according to a first example of the invention,

FIG. 2 is a cross-sectional view along axis II-II of FIG. 1.

FIG. 3 is a detail view of FIG. 2.

FIG. 4 is a cross-sectional view of a roller chain according to a second example of the invention.

FIG. 5 is a detail view of FIG. 4.

FIG. 6 is a schematic view of an assembly process according to the invention.

### DETAILED DESCRIPTION

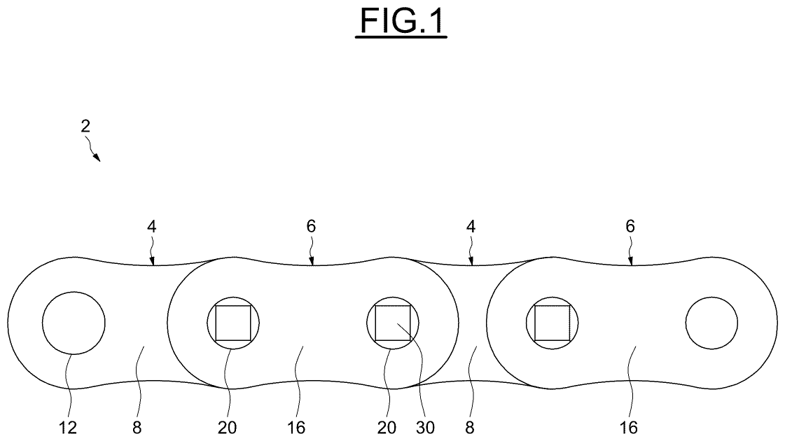

As shown in FIG. 1, a roller chain 2 is formed from a plurality of alternating inner links 4 and outer links 6 connected to each other. Each inner link 4 is arranged between two successive outer links 6 so that the two successive outer links 6 partly overly the inner link 4, the two successive outer links 6 each overlying a different extremity of the inner link 4.

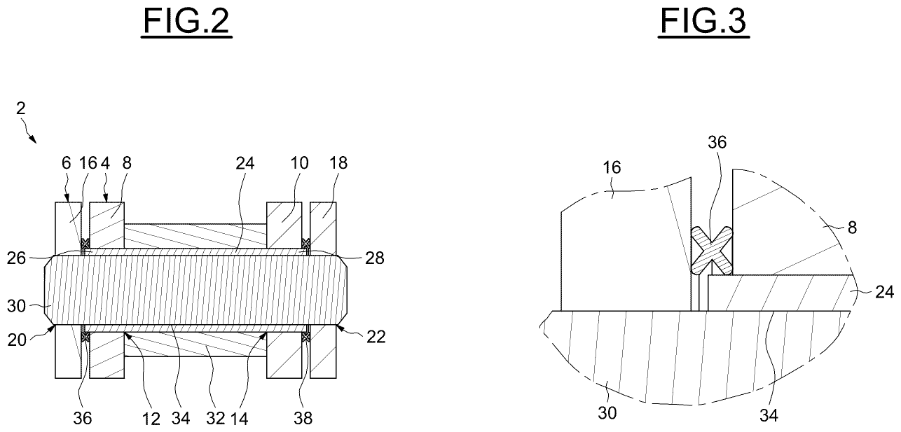

As illustrated more clearly in FIG. 2, each inner link 4 comprises a first inner plate 8 and a second inner plate 10. Both the first and second inner plates 8, 10 of the inner link 4 may be coated with black oxide or be nickel plated. The first inner plate 8 of each inner link 4 has two first through-holes 12 spaced each other, and the second inner plate 10 of each inner link 4 comprises two second through-holes 14 spaced each other and each coaxial of one of the first through-hole 12 of the first inner plate 8 of the inner link 4. The first through-holes 12 of the first inner plate 8 of each inner link 4 are arranged at a distance from the edges of the first inner plate 8. The second through-holes 14 of the second inner plate 10 of each inner link 4 are arranged at a distance from the edges the second inner plate 10.

The second inner plate 10 of each inner link 4 is spaced from the first inner plate 8 of the inner link 4 and parallel to the first inner plate 8 of the inner link 4. Alternatively, the second inner plate 10 of each inner link 4 may be substantially parallel to the first inner plate 8 of the inner link 4.

Each outer link 6 comprises a first outer plate 16 and a second outer plate 18. Both the first and second outer plates 16, 18 of the outer link 6 may be coated with black oxide or be nickel plated.

The first outer plate 16 of each outer link 6 has two first through-holes 20 that are spaced from each other. The second outer plate 18 of each outer link 6 comprises two second through-holes 22 that are spaced each other and each coaxial with one of the first through-hole 20 of the first outer plate 16 of the outer link 6. The first through-holes 20 of the first outer plate 16 of each outer link 6 are arranged at a distance from the edges of the first outer plate 16. The second through-holes 22 of the second outer plate 18 of each outer link 6 are arranged at a distance from the edges the second outer plate 18.

The second outer plate 18 of each outer link 6 is spaced from the first outer plate 16 of the outer link 6 and parallel to the first outer plate 16 of the outer link 6, and the first and second outer plates 16, 18 of each outer link 6 are axially arranged on either side of the first and second inner plates 8, 10 of each inner link 4 covered by the outer link 6. Alternatively, the second outer plate 18 of each outer link 6 may be substantially parallel to the first outer plate 16 of the outer link 6.

The roller chain 2 comprises a plurality of bushes 24, each bush 24 being in the form of a hollow cylinder. Each bush 24 extends axially through a first through-hole 12 of the first inner plate 8 of an inner link 4 and through a second through-hole 14 of the second inner plate 10 of the inner link 4 coaxial with the first through-hole 12. The bush 24 is radially in contact with both first and second inner plates 8, 10 of the inner link 4, and the bush 24 is fixed relative to the inner link 4. A first extremity 26 of the bush 24 protrudes axially outward from the first inner plate 8 of the inner link 4, and a second extremity 28 of the bush 24 axially opposed to the first extremity 26 protrudes axially outwards from the second inner plate 10 of the inner link 4. The bush 24 is axially spaced from both first and second outer plates 16, 18 of the outer link 6 enclosing the bush 24.

Alternatively, the first extremity 26 of the bush 24 may flush the outer radial surface of the first inner plate 8 of the inner link 4 or the first extremity 26 of the bush 24 may be axially offset inwards with respect to this outer radial surface. As another alternative, the second extremity 28 of the bush 24 may be flush with the outer radial surface of the second inner plate 10 of the inner link 4, or the second extremity 28 of the bush 24 may be axially offset inwards with respect to this outer radial surface.

The roller chain 2 comprises a plurality of pins 30, each pin 30 being inserted into a bush 24. Each pin 30 extends axially through a first through-hole 20 of the first outer plate 16 of the outer link 6 axially facing the bush 24 into which the pin 30 is inserted. The pin 30 is in radial contact with the bore of the associated bush 24. The pin 30 extends axially through a second through-hole 22 of the second outer plate 18 of the outer link 6 axially facing the bush 24 into which the pin 30 is inserted. The pin 30 protrudes axially outwards from both first and second outer plates 16, 18 of the outer link 6. The pin 30 is fixed to both first and second outer plates 16, 18 of the outer link 6, the pin 30 being fixed in relation to the outer link 6. Alternatively, other ways of connecting the pin 30 to the outer link 6 are possible.

Each bush 24 can rotate relative to the pin 30 inserted therein so that each inner link 4 is articulated in relation with both outer links 6 connected to the inner link 4.

The roller chain 2 comprises a plurality of rollers 32 each surrounding one bush 24. Each roller 32 extends axially between the first inner plate 8 and the second inner plate 10 of the inner link 4 spanned by the bush 24 that is surrounded by the roller 32. The roller 32 is in radially contact with the bush 24 that is surrounded by the roller 32.

Each bush 24 is sintered and impregnated with a lubricant 34. The bush 24 is porous, and the lubricant 34 extends into the pores of the bush 24. For example, the size of the pores may be between 5 μm and 500 μm, notably between 10 μm and 100 μm. The bore of the bush 24 includes pores that open radially inward, and the outer surface of the bush 24 includes pores that open radially outward. The porous texture of the bush 24 retains the lubricant 34 in the structure of the bush 24 and then releases the lubricant 34 progressively due to the motion of the bush 24.

The relative movement of each bush 24 in relation to the pin 30 inserted inside the bush 24 causes the bush to release lubricant 34 at the interface between the bush 24 and the pin 30 inserted inside the bush 24. For example, the lubricant 34 may comprise oil.

The lubricant 34 may have at least one of the following properties: a density at 15° C. less than 0.9 g/cm³, preferably about 0.897 g/cm³, a viscosity at 40° C. of between 90 mm²/S and 100 mm²/S, preferably about 95.3 mm²/S, a viscosity at 100° C. of between 12 mm²/S and 13 mm²/S, preferably about 12.5 mm²/S, and a flash point greater than 250° C., preferably about 270° C.

To avoid leakage of the lubricant, the roller chain 2 includes a first seal 36 radially surrounding the first extremity 26 of each bush 24 and a second seal 38 radially surrounding the second extremity 28 of each bush 24. As illustrated more clearly in FIG. 3, the first seal 36 is a X-ring seal, a seal with a X-shape cross-section. The second seal 38 is also a X-ring seal.

Each first seal 36 is disposed axially between the first inner plate 8 of the inner link 4 and the first outer plate 16 of the outer link 6 enclosing the inner link 4. The first seal 36 is axially in contact with the outer radial surface of the first inner plate 8 of the inner link 4 and with the inner radial surface of the first outer plate 16 of the outer link 6. The first seal 36 forms a contact seal. The outer radial surface of the first inner plate 8 axially faces the inner radial surface of the first outer plate 16.

Each first seal 36 is in radially contact with the first extremity 26 of the bush 24 which forms a seat for the first seal 36.

Each second seal 38 is disposed axially between the second inner plate 10 of the inner link 4 and the second outer plate 18 of the outer link 6 enclosing the inner link 4. The second seal 38 is in axially contact with the outer radial surface of the second inner plate 10 of the inner link 4 and with the inner radial surface of the second outer plate 18 of the outer link 6, the second seal 38 forming a contact seal. The outer radial surface of the second inner plate 10 axially faces the inner radial surface of the second outer plate 18.

Each second seal 38 is in radially contact with the second extremity 28 of the bush 24 which forms a seat for the second seal 38. Each of the first and second seals 36, 38 is made of an elastomeric material, for example urethane. Alternatively, each of the first and second seals 36, 38 is made of a polymer, for example a fluoroelastomer such as Viton™.

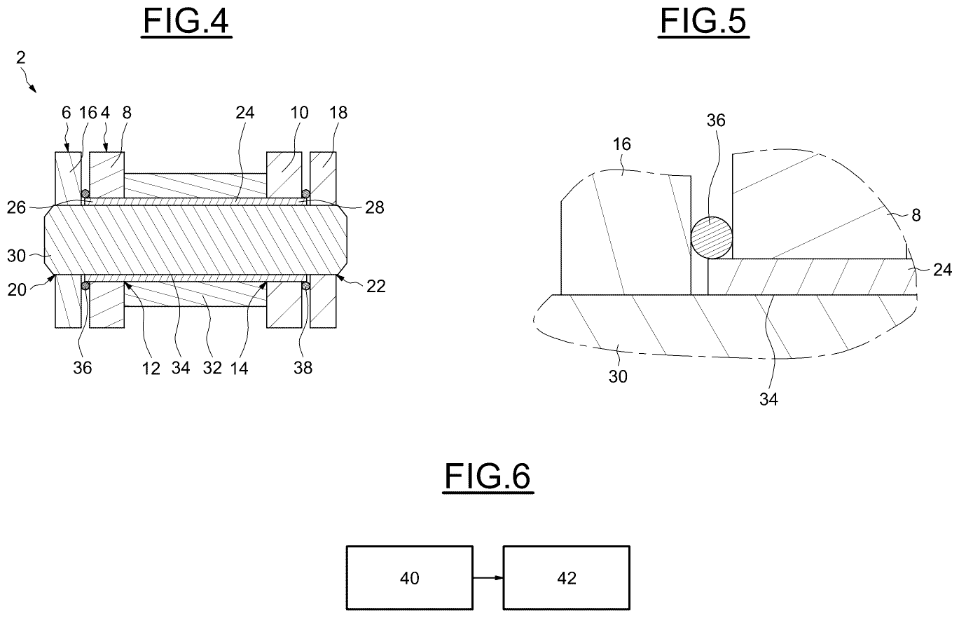

The embodiment shown in FIGS. 4 and 5, in which the identical elements bear the same reference numerals, differs from the previous embodiment in that both the first and second seals 36, 38 are O-ring seals, each having an O-shape cross-section. Alternatively, other shapes of first and second seals 36, 38 are possible, like seals with an H-shape cross-section.

The FIG. 6 schematically illustrates a process for assembling a roller chain 2. The process starts with a lubricant projection step 40 in which the lubricant 34 is projected onto each bush 24 so that the lubricant 34 penetrates the pores of the bush 24.

The process continues with an assembly step 42 of each pin 30, bush 24, roller 32, inner link 4, outer link 6, first and second seals 36, 38 to form the roller chain 2. Each first seal 36 is positioned between a first inner plate 8 of an inner link 4 and a first outer plate 16 of an outer link 6 and squeezed between the first inner plate 8 and the first outer plate 16. Each second seal 38 is positioned between a second inner plate 10 of an inner link 4 and a second outer plate 18 of an outer link 6 and squeezed between the second inner plate 10 and the second outer plate 18.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved lubricated roller chains.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A roller chain comprising:
a bush having a first end and a second end,
a pin extending through the bush and having a first end extending from the first end of the bush and a second end extending from the second end of the bush,
a roller supported by an outer surface of the bush and having a first end and a second end,
a first inner link having a first opening mounted on the bush at the first end of the roller and a second inner link having a first opening mounted on the bush at the second end of the roller,
a first outer link having a first opening mounted on the first end of the pin and a second outer link having a first opening mounted at the second end of the pin, and
a first seal body axially mounted between the first inner link and the first outer link and a second seal body axially mounted between the second inner link and the second outer link,
wherein the bush comprises a sintered cylinder impregnated with a lubricant.

2. The roller chain according to claim 1,
wherein the first end of the bush is located on a side of the first inner link opposite the roller, and
wherein a portion of the first seal body is mounted on the first end of the bush.

3. The roller chain according to claim 2,
wherein the second end of the bush is located on a side of the second inner link opposite the roller, and
wherein a portion of the second seal body is mounted on the second end of the bush.

4. The roller chain according to claim 1,
wherein the first seal body axially contacts the first inner link and the first outer link.

5. The roller chain according to claim 4,
wherein the second seal body axially contacts the second inner link and the second outer link.

6. The roller chain according to claim 1,
wherein the first and second inner links and the first and second outer links are plated with nickel or coated with black oxide.

7. The roller chain according to claim 1,
wherein the first seal body is an X-ring seal body.

8. The roller chain according to claim 1, wherein the first seal body is an O-ring seal body.

9. The roller chain according to claim 1,
wherein the first seal body is made from urethane.

10. The roller chain according to claim 1,
wherein the first seal body is made from a fluoropolymer.

11. The roller chain according to claim 1,
wherein the first seal body is made from Viton™.

12. The roller chain according to claim 3,
wherein the first seal body axially contacts the first inner link and the first outer link, and
wherein the second seal body axially contacts the second inner link and the second outer link.

13. The roller chain according to claim 12,
wherein the first and second inner links and the first and second outer links are plated with nickel or coated with black oxide, and
wherein the first seal body is made from urethane.

14. The roller chain according to claim 12,
wherein the first and second inner links and the first and second outer links are plated with nickel or coated with black oxide, and
wherein the first seal body is made from a fluoropolymer.

15. The roller chain according to claim 12,
wherein the bush includes pores and the lubricant at least partially fills the pores.

16. The roller chain according to claim 1,
wherein the bush includes pores and the lubricant at least partially fills the pores.
